(19) United States
(12) Patent Application Publication
(10) Pub. No.: US 2026/0117733 A1
(43) Pub. Date: Apr. 30, 2026

(54) FUEL INJECTOR TESTING DEVICE

(71) Applicant: Paul Arseneau, Fort Worth, TX (US)

(72) Inventor: Paul Arseneau, Fort Worth, TX (US)

(21) Appl. No.: 18/928,538

(22) Filed: Oct. 28, 2024

Related U.S. Application Data
(60) Provisional application No. 63/603,787, filed on Nov. 29, 2023.

(51) Int. Cl. F02M 65/00

(52) U.S. Cl. CPC F02M 65/001

(57) ABSTRACT

The present disclosure teaches a testing device for fuel injectors. The testing device provides a manual mode and an automatic mode of testing fuel injectors. Wherein, the manual mode is implemented using graduated cylinders, enabling a user to visually perceive the measurement. The graduated cylinders can also be used to calibrate the testing device. Wherein, the automatic mode is implemented using flow sensors, or flow meters. Two flow meters with different ranges of measurement are respectively used to measure the maximum fuel delivery rate and the minimum fuel delivery rate of the tested fuel injectors. The start time of energizing the fuel injectors may be marked as t₁. The time when a flow meter detects a flow through the flow meter may be marked as t₂. The time-offset, or latency time of the tested fuel injectors may be calculated as Tₒ=t₂−t₁.

### TECHNICAL FIELD

The present disclosure relates to the field of engine diagnostics and maintenance, or more specifically, the field of fuel injector testing devices.

### BACKGROUND

Several methods and systems have been developed in the past to test fuel injectors. First, the SAEJ1832 (Society of Automotive Engineers J1832) has taught and recommended an apparatus using a scale for measuring the mass of fluid flowing through the fuel injector. Also, state-of-the-art technologies have taught a method of using a volumetric flow meter or sensor for fuel injector testing. It should be noted that the aforementioned test apparatus is primarily used by OEMs (Original Equipment Manufacturers), however. For the last 20 years or so, the vast majority of performance companies and mechanical garages have used a simple, manual-type test apparatus only consisting of fixed graduated cylinders, wherein an operator can visually see the quantity of fluid entering the cylinders over time. When the measurement is finished, an operator would simply turn the cylinders upside down to empty the contents into a disposal tank.

In the last five years or so, companies have come out with systems along the lines of the SAEJ1832 recommended apparatus either using a mass-type scale or a volumetric flow meter. However, it was hard to calibrate these systems, since the density of the fluid to be used needs to be considered, which has forced users to consistently use the same type of fluid for testing or take a trial-and-error approach by simply entering a calibration constant to adjust the scale.

To address the aforementioned problems, the presently disclosed technology aims to (1) allow both automated and manually operated processes for testing fuel injectors and (2) provide a way to calibrate the machine when different fluids with different densities and viscosities are used for testing.

### SUMMARY

The present disclosure teaches a fuel injector testing device. More particularly, the present disclosure teaches a device to test fuel injector testing device that comprises both graduated cylinders and computerized flow sensors to measure the flow characteristics of one or more fuel injectors. The different modes of measurement may be used independently or in combination, depending on the embodiment.

The present disclosure provides the most engineered, highest precision, and functional SAEJ1832™ Low-Pressure Gasoline Fuel Injector test and flow bench on the market. It provides users the ability to test/flow both fuel injectors and fuel pumps over different voltages and pressures using two different flow methods to give the user the confirmation and validation that the results are both accurate and precise while following the recommended practice. In the prior art, the two solutions are taught as alternatives to reach the same measurement. In many embodiments, the presently disclosed technology's performances exceed the recommended levels of performance regarding both the electronic control system and software capabilities. In one non-limiting embodiment, the device may utilize, for example, a 200 MHz 32 bit processor, 12 bit A/D, Ethernet, Bluetooth, 2x USB ports, a 128×64 graphic display along with user-specific I/O digital and analog output signals.

The present fuel injector test device may be equipped with rectangular (or other shaped) graduated cylinders that allow the user to interact with the machine to measure the specific flow volume of fluid that accumulates within the cylinders over a specific period of time similar to older traditional flow benches that have been on the market for several years. The advantage of using rectangular cylinders is they can hold a larger volume of fluid over that of a circular cylinder when the diameters are identical, and the cylinders are the same height.

This feature provides users with a familiar test apparatus but more importantly, a way to validate that the data that is collected when the machine is run in a fully automated microcontroller control method using the dual built-in precision positive displacement electronic flow sensors-one flow sensor for very low fluid flow rates and a second, larger flow sensor, for much higher flow rates up to 12000 cc/m. When using test fluid of different densities, the flow meters will have to be calibrated; hence, the built-in graduated cylinders provide a means to calibrate between volume and mass by a simple mathematical conversion.

Hence, the ability to incorporate graduated cylinders that have open/close valves solves this problem while also giving users the option to manually measure static and/or dynamic flow using the graduated cylinder, or, when the valves are open, using the automatic computer-controlled system with in-built flow sensors, provides a substantial improvement to the art.

As discussed in the background section, the presently disclosed technology has not been developed before for a few reasons. First, flowing fuel injectors for testing is a relatively new thing (developed about 10 years before), and previously, it was done manually using only graduated cylinders. Second, the new automated machines only started coming out in the last 2-3 years and the state-of-the-art automated devices are equipped with only mass or volume flow sensors.

Hence, the presently disclosed technology aims to (1) allow both automated and manually operated processes for testing fuel injectors and (2) provide a way to calibrate the machine when different fluids with different densities and viscosities are used for testing.

As automated type machines age, the volumetric flow area of the lines and even the sensor(s) can suffer from debris, contamination, and chemical matter build-up. The state-of-the-art solution is to dismantle the machine to clean the lines and sensors. Another recommended practice is to only use fluid of one type and to avoid cross fluid contamination. It is further recommended to limit the prolonged use of old fluid. The inclusion of manual or automated valves and graduated cylinders is likely the most cost-sensitive solution to the aforementioned problems. It also provides other benefits to operators, such as allowing them to reuse fluid while simply needing to calibrate the sensors after a period of time, allowing them to use different types of fluids, as well as providing a visually positive method to validate the automated data.

Details regarding terminology and recommended testing for this are mentioned in the SAEJ1832 Oct. 2016 document, whose entirety is incorporated and referenced herein. For simplicity, this document is referred to below as SAEJ1832.

One set of data that is important for selling, testing, and using injectors is latency or dead time. The latency or dead time may also be referred to as lag time, injector offset, opening time, dead time, or latency, but the common name referenced within the SAEJ documents is called the: “time-offset” per SAEJ1832 section 3.2.33 as referenced below:
3.2.33 Time-Offset (X) The displacement of the calculated linear regression flow curve from the origin along the ordinate x-axis, which is the pulsewidth axis. The units are in milliseconds (ms).

The time-offset is usually computed using linear regression formulas per section 5.7.3.1 of the SAEJ1832, or by using an electronic testing apparatus including an accelerometer, as well as following the procedure referenced at the beginning of section 5.3 of the SAEJ1832 document. It should be noted that opening time is, however, different from the time-offset and/or latency.

The presently disclosed technology also includes a unique, effective, simple, and accurate method for measuring the time-offset/latency utilizing sensors and electronics incorporated within the presently disclosed fuel injector testing device. The method may include the use of flow meters, electronic circuitry using digital interrupts, and firmware.

The concepts discussed below are crucial to the understanding of the presently disclosed technology.

CPU/MCU clock frequency—In computing, the clock rate or clock speed typically refers to the frequency at which the clock generator of a processor generates pulses, which are used to synchronize the operations of its components or execute instructions. For example, a 200 MHz clock frequency can generate or calculate pulse times at a period of T=1/f, which is 5 ns.

Positive Displacement Volumetric Flow Meters-They may include oval gear, gear, piston, and others. There are also many types of volumetric flow meters in general. A key characteristic of current flow meters that is and has been known for many years in the flow measuring industry is the flow meter K-factor. The K-factor represents the relationship between the flow rate passing through the flow meter and the output signal generated by the meter. These flow meters either send out a digital pulse or an analog voltage used to measure flow. In this embodiment, the digital pulse is used along with interrupt pin(s) on the CPU/MCU for very precise measurement and timing over that of the analog voltage output; however, either output signal can be configured to be used. The digital output pulse also has the advantage when the machine is used to measure time offset or latency.

In some embodiments, other types of flow meters may be used, such as a Coriolis flow meter, a turbine flow meter, an ultrasonic flow meter, an electromagnetic flow meter, etc.

Another key characteristic is the number of digital pulses a flow meter generates on an output signal in response to the detection of a flow. For example, a flow meter may be able to output a digital pulse at a very small flow rate, wherein the output signal can be used to measure the time-offset of a fuel injector being tested.

The presently disclosed technology also teaches the method described below:

For a bench of fuel injectors for testing, a user may enable a fluid pump of the presently disclosed testing device and set the internal pressure of the testing device using a pressure regulator as described in SAEJ1832. Once the bench of fuel injectors is initialized, we will set a trigger or start a timer at a time an injector to be tested is energized. This time will be called t₁. When the injector is energized, the fluid will begin to flow through the injector, the fluid lines, and the flow sensor in the testing device. The flow sensor and the fluid lines can assist in increasing the precision of data collected per applicable laws of fluid dynamics. The fluid flow will cause the flow meter (which, in some embodiments, may be a positive displacement gear type flow meter; however, other flow meters can be used) to output a digital pulse when it detects an amount of fluid to start flowing. In this case, this output signal is connected to a digital input pin configured to generate a system interrupt and MCU clock tick, which is well understood by a person with ordinary skills in the specific art or field of embedded electronics/engineering. Other time systems or electronic circuitry may also be used, such as a simple digital counter, a digital latch, an analog-type discrete electronic circuit, or a sophisticated FPGA—there are many electronic digital and analog circuits specifically designed to measure timing and events. The digital (or analog) electronic signal will go to an input pin of the system's MCU (or another type of electronic circuitry) on a special pin called an interrupt pin or, for an analog signal, an Analog to Digital input. Other types of pins may also be used, such as digital trigger pins, or event pins as mentioned in 4. The time of the event that an output pulse is generated from the flow sensor or flow meter will be called t₂. This is generally the very first pulse captured as soon as the sensor detects fluid flow. Hence, the time-offset or latency time, called T_{O} is the difference between t₂ and t₁: T_{O}=t₂−t₁.

To summarize, the presently disclosed system may measure the time from the start of the injector energizing to the trigger time of the interrupt pin. This time is the time-offset, or the latency time. Since MCUs run at very high clock frequencies (e.g. in one embodiment, 200 MHz), the timing can be very accurate-typical latency times are 0.1 to 0.2 ms but using the method described above and utilizing digital signals and interrupts, the precision of the presently disclosed testing device can be in the nanoseconds. The precision may vary depending on the circuitry used as well as the routing and design of the fluid lines.

Moreover, the presently disclosed testing device may further multiple flow sensors with different specifications and characteristics to broaden the range of measurement and improve the accuracy of measurement. Fuel injectors may have different sizes, specifications, configurations, and characteristics: for example, they may come with the labels of 19 lbs/hr, 30 lbs/hr, 300 cc/min, 1000 cc/min, 100 lbs/hr, or 850 lbs/hr. These labels represent the volume of fuel that can be delivered over time when operated wide open (fuel injector is open and not at a varying frequency) at a specific pressure (in most cases this is 3 bar or 43 PSI, but it can also be some other pressure value). However, the particular fuel injector characterization not only has a maximum fuel delivery rate but also includes a minimum fuel delivery rate, which may be very small and thus hard to detect. In order to measure this value, a flow meter with a much smaller measuring range must be used, given that most flow meters have a limited range of operation. The flow rate needs to be within the measuring range of the flow meter to be detected or measured accurately. Hence, if only one flow meter is included in the testing device, the testing device may only be able to measure fuel injectors with a small range of fuel delivery rates. Hence, it would be helpful to include more than one flow meter or sensor with different measuring ranges, and to provide a method to switch between flow meters or flow sensors with different specifications and ranges of operations, It should be noted that the mass flow rate at different pressures can be computed once the mass flow rate is measured at a particular pressure using fluid dynamics equations of Bernouilli and Hagen-Poiseuille. More specifically, Q2=Q1×(P2/P1)\hat{ }0.5, where Q represents the mass flow rate and P represents fluid pressure.

The calculations can be done in Firmware/Software of the machine automatically and the different volumetric flow rates displayed for different pressures.

State-of-the-art testing devices do not use more than one flow meter or sensor. Using different types of flow meters/sensors or using flow meters/sensors with different specifications can allow the presently disclosed testing machine to reach a wider range of measurements, enabling the testing machine to measure the fuel delivery rates of various fuel injectors, with a wide range of specifications, accurately. A three-way valve or similar components may be used to switch between the different flow meters or sensors.

In some embodiments, two flow meters, one for measuring the maximum fuel delivery rate of the fuel injector(s), and another for measuring the minimum fuel delivery rate of the fuel injector(s), may be included in the presently disclosed testing device, and an electronic ball valve may be included to switch between the two flow meters. In actual practice, since a very small meter may be damaged by having a high flow rate, a 2-way solenoid valve may be placed before the small valve entry, and a one-way check valve may be placed on its exit port to prevent fluid from flowing backward through the meter. Most positive-displacement type flow meters have an arrow showing a direction of flow. In some embodiments, the testing device may include a positive displacement gear type of flow meter, but other types of flow meters may also be used. In some embodiments, the testing device may include two flow meters. In some other embodiments, the testing device may include more than two flow meters. Furthermore, when using flow meters of different specifications and sizes, the sizes of flow lines may also be adjusted to optimize the measurement of flow meters. The flow lines may be sized to suit the specifications of each flow sensor. For example, smaller flow sensors may have a smaller-diameter flow tube installed for input into these flow sensors.

### BRIEF DESCRIPTION OF THE DRAWINGS

The present disclosure is further illustrated by way of exemplary embodiments, which are described in detail through the accompanying drawings. These embodiments are not limiting, and in these embodiments, the same numbering indicates the same structure, wherein:

FIG. 1 is an isometric front view diagram of the fuel injector testing device, according to some embodiments of the present disclosure.

FIG. 2 is a back view diagram of the fuel injector testing device, according to some embodiments of the present disclosure.

FIG. 3A is a schematic diagram illustrating a plumbing layout of the fuel injector testing device, according to a first exemplary embodiment of the present disclosure.

FIG. 3B is a schematic diagram illustrating a modified plumbing layout of the fuel injector testing device, according to a second exemplary embodiment of the present disclosure.

FIG. 4 is a flow diagram illustrating a process of testing one or more fuel injectors, using the presently disclosed fuel injector testing device, according to some embodiments of the present disclosure.

### DETAILED DESCRIPTION

In order to more clearly illustrate the technical solutions of the embodiments of the present disclosure, the accompanying drawings for the description of the embodiments are described below. Obviously, the accompanying drawings in the following description are only some examples or embodiments of the present disclosure, and it is possible for a person of ordinary skill in the art to apply the present disclosure to other similar scenarios in accordance with these accompanying drawings without creative labor. Unless obviously obtained from the context or the context illustrates otherwise, the same numeral in the drawings refers to the same structure or operation.

It should be understood that the terms “system,” “device,” “unit,” and/or “module” are used herein as a way to distinguish between different components, elements, parts, sections, or assemblies at different levels. However, if other words may achieve the same purpose, the terms may be replaced with alternative expressions.

As indicated in the present disclosure and in the claims, unless the context clearly suggests an exception, the words “one,” “a,” “a kind of,” and/or “the” do not refer specifically to the singular but may also include the plural. In general, the terms “include” and “comprise” suggest only the inclusion of clearly identified steps and elements, which do not constitute an exclusive list, and the method or device may also include other steps or elements.

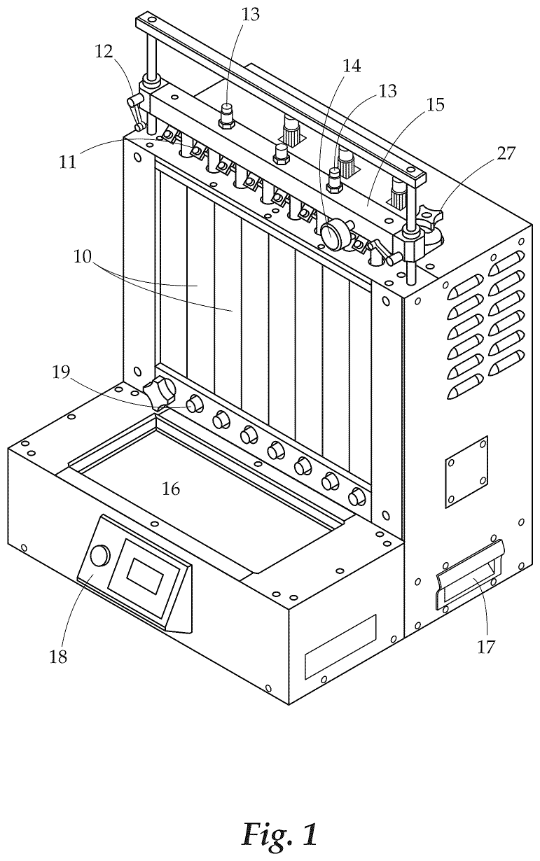

FIG. 1 is an isometric front view diagram of the fuel injector testing device, according to some embodiments of the present disclosure.

A plurality of fuel injectors 11 may be mounted onto the testing device. In some embodiments, the fuel injectors may be port fuel injectors or direct fuel injectors. In some embodiments, the fuel injectors 11 may be identical. In some embodiments, the testing device may accommodate fuel injectors 11 of different sizes and shapes. In some embodiments, the fuel injectors 11 may be placed in parallel to each other.

In some embodiments, the testing device may include a plurality of graduated cylinders 10 placed in parallel with each other, each of the plurality of graduated cylinders placed under one of the one or more fuel injectors 11. In some embodiments, the fuel injectors 11 may be configured and oriented to discharge fluid into graduated cylinders 10. In some embodiments, the graduated cylinders 10 may be tall, narrow, and cylindrical, having marked lines or graduations along their length that indicate volumes. In some embodiments, the graduated cylinders 10 may be made of glass or plastic. In some embodiments, a user may read the measurements of the graduated cylinders 10 from the marked lines or graduations. In some embodiments, the graduated cylinders 10 may be identical. In some embodiments, the graduated cylinders 10 may have different diameters, so they may have different measuring ranges and precision levels.

In some embodiments, the testing device may include a flow injector test head 15 to dispense fluid into the fuel injectors 11. In some embodiments, the testing device may include adjustable head/rail locks 12 to securely position and adjust the flow-injector test head 15. In some embodiments, the testing device may include temperature and pressure sensors 13 and an analog fluid pressure gauge 14 to monitor the temperature and pressure of the fluid input into the fuel injectors 11. In some embodiments, the temperature and pressure sensors 13 and the analog fluid pressure gauge 14 may be mounted onto the flow-injector test head 15.

The testing device may further include a plurality of valves 19, each of the plurality of valves connected to and placed at the bottom of each of the one or more graduated cylinders 10. In some embodiments, the plurality of valves 19 may be opened or closed. In some embodiments, the plurality of valves 19 may be butterfly valves. In some embodiments, the opening and closing of the plurality of valves 19 may be used to select between a manual test mode using the graduated cylinders and an automatic test mode using flow meters or sensors 40/41/43. In some embodiments, the one or more valves 19 may be open when the graduated cylinders 10 are used for measurement and closed when the digital flow meters or sensors 40/41/43, placed inside the housing of the testing device, are used for measurement.

The testing device may further include an access panel 16, which provides access to the internal components. A graphical user interface 18 is positioned at the front of the machine to display the outputs, including outputs of the graduated cylinders 10 and the flow meters 40 and 41, and receive inputs from a user. Two handles 17 may be placed on each side of the testing device for easy transport and orientation.

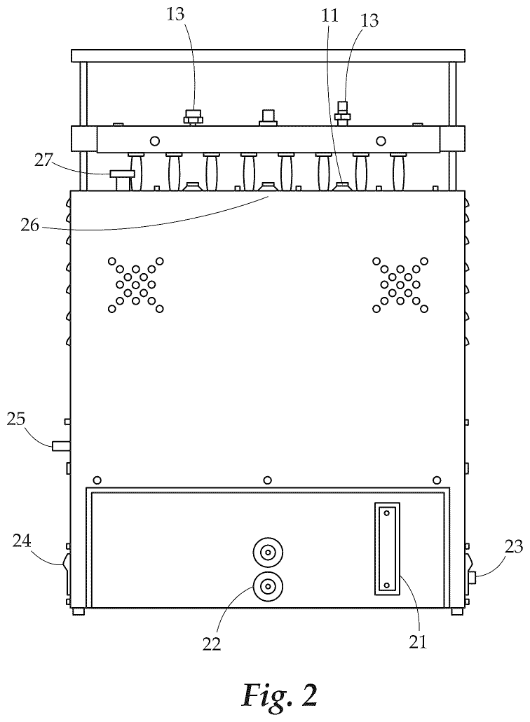

FIG. 2 is a back view diagram of the fuel injector testing device, according to some embodiments of the present disclosure.

As shown in FIG. 2, the testing device may further include an external fuel pump mount 21, a fluid drain and supply fittings 22, and a cleaning port 23. In some embodiments, the testing device may also include a computerized I/O connection 24, and a power connection 25 on a side. The testing device may further include a fluid temperature and pressure sensor port 26 for connecting temperature and pressure sensors to the device. In some embodiments, the testing device may include a pressure regulator 27 communicating with the injector test head 15.

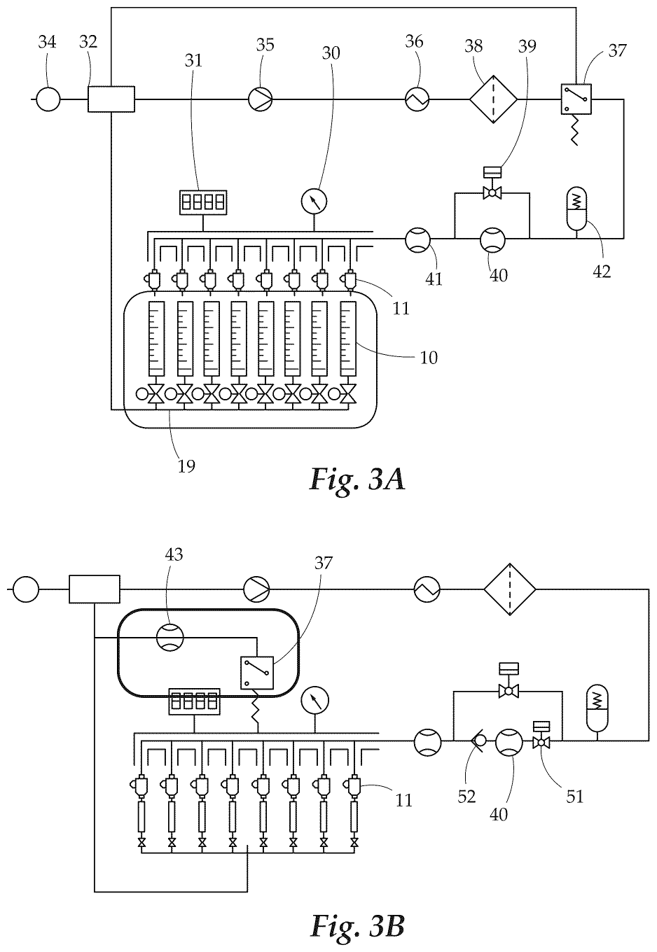

FIG. 3 is a schematic diagram illustrating a plumbing layout of the fuel injector testing device, according to a first exemplary embodiment of the present disclosure.

As shown in FIG. 3 and discussed above, the presently disclosed testing device may include a plurality of fuel injectors 11. In some embodiments, a pressure gauge 30 and a temperature gauge 31 may be connected to the plurality of fuel injectors 11. In some embodiments, each of the plurality of fuel injectors 11 may dispense fluid into each of the plurality of graduated cylinders 10. In some embodiments, a plurality of valves 19 may be connected to the graduated cylinders 10 to open or close the flows. In some embodiments, the plurality of valves 19 may be butterfly valves. In some embodiments, the plurality of valves 19 may be manual or solenoid. In some embodiments, the plurality of flows out of the plurality of valves 19 may converge into one flow. As discussed above, in some embodiments, the opening and closing of the plurality of valves 19 may be used to select between a manual test mode using the graduated cylinders and an automatic test mode using flow meters or sensors 40/41/43. When the plurality of valves 19 are closed, the fluid dispensed by the fuel injectors 11 may accumulate inside the graduated cylinders 10, and the graduated cylinders may be used for measuring the amount of fluid dispensed. When the plurality of valves 19 are opened, the fluid dispensed by the fuel injectors 11 may pass the graduated cylinders 10 for further measurements by the flow meters or sensors 40/41/43.

In some embodiments, the converged flow may be further directed to and pass a fluid reservoir 32. In some embodiments, a level gauge 34 may be attached to the fluid reservoir 32. From there, the flow may pass a pressure regulator 37, which may be used to adjust the pressure in the testing device, and one or more flow sensors or meters 40, 41, and 43. In some embodiments, there may be an extra return line directly connecting the pressure regulator 37 and the fluid reservoir 32. Other components, such as pumps, various sensors, valves, and filters, may also be placed along the fluid line from the fluid reservoir 32 back to the fuel injectors 11. In one embodiment, as shown in FIG. 3, these components may include a pump 35, a heating exchanger 36, a fuel filter 38, and a pressure accumulator 42.

As discussed above, in some embodiments, two flow meters/sensors, with different specifications and ranges of measurement, may be used to respectively measure the minimum and maximum fuel delivery rates of the fuel injectors. In some embodiments, the first flow meter 40 may be used to measure the minimum fuel delivery rate of the plurality of fuel injectors 11, and the second flow meter 41 may be used to measure the maximum fuel delivery rate of the plurality of fuel injectors. A 3-way ball valve 39, may be placed in parallel to the first flow meter 40 with the smaller ranges of measurement. As discussed above, given that a very small meter may be damaged by a high flow rate, the 3-way ball valve 39, when opened, may be used to bear most of the flow and protect the first flow meter 40, when the maximum fuel delivery rate is measured. Furthermore, in conjunction with the 3-way ball valve 39, a solenoid valve 51 (FIG. 3B) may be placed in front of the first flow meter 40 to block flow to the first flow meter 40 and the 3-way ball valve 39, when opened, will bear all of the flow. In another scenario, when measuring small ranges of measurement, the 3-way ball valve, when closed, will direct all the flow through the flow meters 40 and 41 in FIG. 3A.

FIG. 3B is a schematic diagram illustrating a modified plumbing layout of the fuel injector testing device, according to a second exemplary embodiment of the present disclosure.

As shown in FIG. 3B, in the second exemplary embodiment, the pressure regulator 37 may be placed along an additional fluid line from the plurality of fuel injectors 11 back to the fluid reservoir 32, instead of on the fluid line from the fluid reservoir 32 to the plurality of fuel injectors 11, as in the first exemplary embodiment. The advantage of this change is that the pressure regulation may be more stable, which is critical for controlling the test device. However, in doing so, a third flow meter 43 is required in the system to measure the flow volume of fluid being returned to the fluid reservoir 32 along the additional fluid line. The actual flow through the plurality of fuel injectors 11 would be the difference between the measurement of the first flow meter 40 or the second flow meter 41, and the third flow meter 43.

Moreover, as discussed above, since a very small meter may be damaged by having a high flow rate, a 2-way solenoid valve 51 may be placed before the entry of the first flow meter 40, and a one-way check valve 52 may be placed on the exit port of the first flow meter to prevent fluid from flowing backward through the meter.

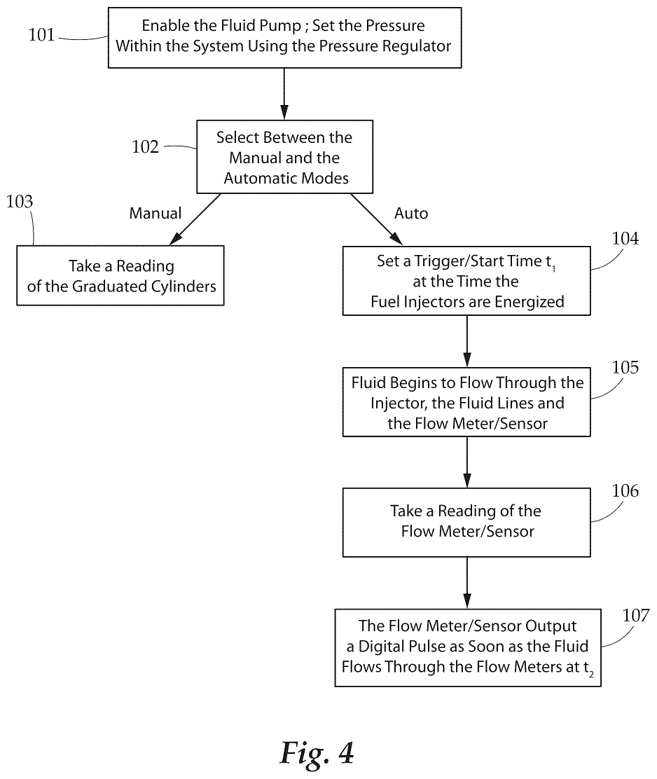

FIG. 4 is a flow diagram illustrating a process of testing one or more fuel injectors, using the presently disclosed fuel injector testing device, according to some embodiments of the present disclosure.

At 101, a user may enable the fluid pump and set the pressure within the presently disclosed system using the pressure regulator 27, in accordance with the SAEJ1832. In some embodiments, the user may also calibrate the testing device using the graduated cylinders 10 before testing.

At 102, the user may select between an automatic test mode and a manual test mode. If the automatic test mode is selected, the plurality of valves 19 may be opened, for the fluid to pass through the flow meters/sensors 40/41/43. If the manual test mode is selected, the plurality of valves 19 may be closed, allowing the fluid to accumulate in the graduated cylinders 10.

If the manual mode is selected, at 103, the readings of the graduated cylinders 10 may be taken. In some embodiments, the graduated cylinders 10 are configured so that a user is able to visually perceive a measurement from them, enabling the readings of the graduated cylinders to be taken manually.

If the automatic mode is selected, at 104, once the plurality of fuel injectors 11 is initialized, a trigger or a start timer may be set at the time the injector is energized. The time may be called t₁.

At 105, the fluid may begin to flow through the plurality of fuel injectors 11, the fluid lines, and the flow meter(s) 40, 41, or 43. In some embodiments, a person with ordinary skills in the arts may adjust the location(s) of the flow meter(s) 40, 41, or 43, as well as the layout and size(s) of the fuel lines, to optimize the precision of the measurement of the flow sensors.

At 106, if the automatic test mode is selected, the readings of the flow sensors or meters 40/41/43 may be taken. As discussed above, in some embodiments, different flow sensors or meters may be automatically or manually selected to measure the maximum or minimum fuel delivery rate of the fuel injectors 11 or measure fuel injectors with different specifications.

At 107, the flow meters or sensors 40, 41, or 43 may output a digital pulse as soon as it detects an amount of fluid flowing through the flow meters. In some embodiments, the output signal of the flow meters or sensors 40, 41, or 43 may be connected to one or more digital input pins of an MCU in the testing device, configured to generate a system interrupt and MCU clock tick, which is well understood by a person of ordinary skills in the arts. In some embodiments, alternatively, other time systems or electronic circuitry known in the arts may be implemented to perform the same task, such as a digital counter, a digital latch, analog-type discrete electronic circuits, or an FPGA. In some embodiments, the digital input pins may be interrupt pins. In some embodiments, the digital input pin(s) may be another type of pin(s), such as a digital trigger pin(s), or event pin(s). The time the output pulse is generated from the flow meter(s) may be called t₂.

At 108, the time-offset or latency time, called T_{O} may be calculated as the difference between t₂ and t₁: T_{O}=t₂-t₁.

Furthermore, unless explicitly stated in the claims, the use of order, numbers, letters, or other names for processing elements and sequences is not intended to limit the order of the processes and methods of the present disclosure. While various examples have been discussed in the disclosure as currently considered useful embodiments of the invention, it should be understood that such details are provided for illustrative purposes only. The appended claims are not limited to the disclosed embodiments, and instead, the claims are intended to cover all modifications and equivalent combinations within the scope and essence of the embodiments disclosed in the present disclosure. For example, although the described system components may be implemented through a hardware device, they may also be realized solely through a software solution, such as installing the described system on an existing processing or mobile device.

Similarly, it should be noted that, for the sake of simplifying the presentation of embodiments disclosed in the present disclosure and aiding in understanding one or more embodiments of the present disclosure, various features have been sometimes combined into a single embodiment, drawing, or description. However, this manner of disclosure does not imply that the features required by the claims are more than the features mentioned in the claims. In fact, the features of the embodiments are less than all the features of the single embodiment disclosed in the foregoing disclosure.

In some embodiments, numeric values describing the composition and quantity of attributes are used in the description. It should be understood that such numeric values used for describing embodiments may be modified with qualifying terms such as “about,” “approximately” or “generally”. Unless otherwise stated, “about,” “approximately” or “generally” indicates that a variation of +20% is permitted in the described numbers. Accordingly, in some embodiments, the numerical parameters used in the disclosure and claims are approximations, which can change depending on the desired characteristics of the individual embodiment. In some embodiments, the numerical parameters should take into account a specified number of valid digits and employ a general manner of bit retention. Although the numerical ranges and parameters used in some embodiments of the present disclosure to confirm the breadth of the range are approximations, in specific embodiments, such numerical values are set as precisely as practicable.

With respect to each of the patents, patent applications, publications of patent applications, and other material, such as articles, books, specifications, publications, documents and the like, cited in the present disclosure, the entire contents thereof are hereby incorporated herein by reference. Application history documents that are inconsistent with the contents of the present disclosure or that create conflicts are excluded, as are documents (currently or hereafter appended to the present disclosure) that limit the broadest scope of the claims of the present disclosure. It should be noted that in the event of any inconsistency or conflict between the descriptions, definitions, and/or use of terminology in the materials appended to the present disclosure and the contents described herein, the descriptions, definitions, and/or use of terminology in the present disclosure shall prevail.

In closing, it should be understood that the embodiments described in the present disclosure are used only to illustrate the principles of the embodiments of the present disclosure. Other deformations may also fall within the scope of the present disclosure. Therefore, by way of example and not limitation, alternative configurations of the embodiments disclosed in the present disclosure may be considered consistent with the teachings of the present disclosure. Accordingly, the embodiments described in the present disclosure are not limited to the explicitly introduced and described embodiments in the present disclosure.

What is claimed is:

1. A device for testing fuel injectors, comprising:
a plurality of fuel injectors;
a plurality of graduated cylinders, configured to measure an amount of fuel dispensed by the plurality of fuel injectors, each of the plurality of graduated cylinders corresponding to one of the plurality of fuel injectors;
wherein the plurality of fuel injectors is configured and oriented to discharge fluid into the plurality of graduated cylinders;
a plurality of valves, configured to regulate a first flow through the plurality of graduated cylinders, each of the plurality of valves corresponding to and connected to one of the plurality of graduated cylinders;
a fuel reservoir, connected to the plurality of valves;
a pressure regulator, connected to the fuel reservoir;
a first flow sensor, configured to measure a minimum fuel delivery rate of the plurality of fuel injectors and connected to the pressure regulator;
a second flow sensor, configured to measure a maximum fuel delivery rate of the plurality of fuel injector and connected to the first flow sensor;
a check valve, connected in parallel to the first flow sensor;
wherein, the second flow sensor is also connected to the plurality of fuel injectors.

2. The device in claim 1, wherein the first flow sensor and the second flow sensor are configured to output a digital pulse in response to detecting a second flow.

3. The device in claim 2, wherein the digital pulse is directed to a pin of an MCU, causing a system interrupt and a clock tick.

4. The device in claim 1, further comprising a fuel pump.

5. The device in claim 1, wherein a user is able to visually perceive a measurement of the graduated cylinders.

6. The device in claim 1, further comprising a flow injector test head, configured to dispense fuel into the plurality of fuel injectors.

7. The device in claim 6, further comprising one or more temperature and pressure sensors and an analog fluid pressure gauge mounted onto the flow injector test head.

8. A device for testing fuel injectors, comprising:
a plurality of fuel injectors;
a plurality of graduated cylinders, configured to measure an amount of fuel dispensed by the plurality of fuel injectors, each of the plurality of graduated cylinders corresponding to one of the plurality of fuel injectors;
wherein the plurality of fuel injectors is configured and oriented to discharge fluid into the plurality of graduated cylinders;
a plurality of valves, configured to regulate a first flow through the plurality of graduated cylinders, each of the plurality of valves corresponding to and connected to one of the plurality of graduated cylinders;
a fuel reservoir, connected to the plurality of valves;
a first flow sensor, configured to measure a minimum fuel delivery rate of the plurality of fuel injectors and connected to the fuel reservoir;
a second flow sensor, configured to measure a maximum fuel delivery rate of the plurality of fuel injector and connected to the first flow sensor;
a check valve, connected in parallel to the first flow sensor;
wherein, the second flow sensor is also connected to the plurality of fuel injectors;
a return fluid line from the plurality of fuel injectors to the reservoir, including a pressure regulator and a third flow meter.

9. The device in claim 8, wherein the first flow sensor and the second flow sensor are configured to output a digital pulse in response to detecting a second flow.

10. The device in claim 9, wherein the digital pulse is directed to a pin of an MCU, causing a system interrupt and a clock tick.

11. The device in claim 8, further comprising a fuel pump.

12. The device in claim 8, wherein a user is able to visually perceive a measurement of the graduated cylinders.

13. The device in claim 8, further comprising a flow injector test head, configured to dispense fuel into the plurality of fuel injectors.

14. The device in claim 13, further comprising one or more temperature and pressure sensors and an analog fluid pressure gauge mounted onto the flow injector test head.

15. A method for testing a plurality of fuel injectors using a testing device, comprising:
setting a pressure within the testing device using a pressure regulator of the testing device;
selecting an option between a manual test mode and an automatic test mode;
in response to the option being the manual test mode:
energizing a plurality of fuel injectors mounted onto the testing device;
wherein, the plurality of fuel injectors is configured to dispense fuel into a plurality of graduated cylinders;
obtaining a first measurement from the plurality of graduated cylinders;
in response to the option being the automatic testing mode;
energizing the plurality of fuel injectors;
marking a first time for energizing the plurality of fuel injectors;
marking a second time for a flow meter of the testing device detecting a flow from the fuel injectors;
calculating a latency time as a difference between the second time and the first time.

16. The method in claim 15, further comprising:
calibrating the testing device using the plurality of graduated cylinders.

17. The method in claim 15, wherein the testing device includes a first and a second flow meters with different measuring ranges, the first flow meter for detecting a maximum fuel delivery rate of the plurality of fuel injectors, the second flow meter for detecting a minimum fuel delivery rate for the plurality of fuel injectors.

18. The method in claim 15, wherein the selecting of the option between the manual mode and the automatic mode is achieved by opening and closing a plurality of valves connected to the plurality of graduated cylinders.

19. The method in claim 17, wherein a check valve connected in parallel with the second flow meter is used to select between the first flow meter and the second flow meter.

20. The method in claim 15, wherein a user is able to visually perceive a measurement of the graduated cylinders.
